(19) United States
(12) Patent Application Publication
(10) Pub. No.: US 2026/0319188 A1
(43) Pub. Date: Oct. 15, 2026

(54) OPTICAL CONNECTOR

(71) Applicant: SUMITOMO ELECTRIC INDUSTRIES, LTD., Osaka-shi (JP)

(72) Inventors: Tsutaru KUMAGAI, Osaka (JP); Tetsuya NAKANISHI, Osaka (JP); Dai SASAKI, Osaka (JP)

(73) Assignee: SUMITOMO ELECTRIC INDUSTRIES, LTD., Osaka-shi (JP)

(21) Appl. No.: 19/637,009

(22) Filed: Apr. 2, 2026

(30) Foreign Application Priority Data
Apr. 10, 2025 (JP) 2025-065083

(51) Int. Cl. G02B 6/38; G02B 6/36

(52) U.S. Cl. CPC G02B 6/3893; G02B 6/3664; G02B 6/3883; G02B 6/3885

(57) ABSTRACT

An optical connector according to one embodiment is an optical connector to be connected to an adapter along a first direction. The optical connector includes an optical waveguide portion configured to guide light, a holding member configured to hold the optical waveguide portion, a guide portion provided at the holding member and configured to perform positioning with respect to the adapter, and a spring configured to urge the holding member toward the adapter. The optical waveguide portion extends in a second direction on an end surface of the holding member in the first direction, the second direction intersecting the first direction. The optical waveguide portion and the guide portion are arranged along a third direction on the end surface, the third direction intersecting the first direction and the second direction. The spring and the guide portion are arranged along the first direction.

### CROSS REFERENCE TO RELATED APPLICATIONS

This application claims priority based on Japanese Patent Application No. 2025-065083 filed on Apr. 10, 2025, and the entire contents of the Japanese patent application are incorporated herein by reference.

TECHNICAL FIELD

The present disclosure relates to an optical connector.

### BACKGROUND

Patent Literature 1 (Japanese Unexamined Patent Application Publication No. 2009-122354) describes an optical module including a circuit board and a transmitter optical subassembly mounted on the circuit board. The transmitter optical subassembly includes an LD element module and an optical block optically coupled to the LD element module. The optical block has a stopper portion for reinforcing the optical block. The stopper portion has a convex protrusion including a receiving portion projecting from the stopper portion, and a guide pin. The stopper portion has two convex protrusions, and a lens array is disposed between the two convex protrusions.

Patent literature 2 (Japanese Unexamined Patent Application Publication No. 2009-134262) describes an optical connector. The optical connector has a connection end surface that serves as a connection surface with an opponent connector. Multiple optical fiber insertion holes arranged in a lateral line and two fitting holes for positioning are opened in the connection end surface. In the connection end surface, the fitting holes are formed above and below the multiple optical fiber insertion holes, respectively.

Patent Literature 3 (U.S. Patent Application Publication No. 2024/0427097) describes an optical connecter unit that is optically coupled to a photonic assembly that performs light incidence and emission on a surface of a substrate. A fiber array units assembly is connected to the optical connecter unit. The fiber array units assembly includes a fiber array and a guide pin located above the fiber array. The optical connecter unit has an optical waveguide optically coupled to an optical fiber of the fiber array units assembly, and a guiding hole into which the guide pin is inserted.

### SUMMARY

An optical connector according to the present disclosure is an optical connector to be connected to an adapter along a first direction. The optical connector includes an optical waveguide portion configured to guide light, a holding member configured to hold the optical waveguide portion, a guide portion provided at the holding member and configured to perform positioning with respect to the adapter, and a spring configured to urge the holding member toward the adapter. The optical waveguide portion extends in a second direction on an end surface of the holding member in the first direction, the second direction intersecting the first direction. The optical waveguide portion and the guide portion are arranged along a third direction on the end surface, the third direction intersecting the first direction and the second direction. The spring and the guide portion are arranged along the first direction. A position of the guide portion in the third direction coincides with a position of the spring in the third direction.

### BRIEF DESCRIPTION OF THE DRAWINGS

FIG. 1 is a perspective view of an optical connector according to an embodiment.

FIG. 2 is a perspective view showing an example of a holding member, a guide portion, and an optical waveguide portion of the optical connector of FIG. 1.

FIG. 3 is a perspective view showing the holding member, the guide portion, the optical waveguide portion, a spring and a latch structure of the optical connector of FIG. 1.

FIG. 4 is a diagram showing the optical connector and an adapter of FIG. 1.

FIG. 5 is a diagram showing a state where an adapter of FIG. 4 is engaged by a latch structure.

FIG. 6 is a side view showing a state where an optical connector is connected to the adapter of FIG. 4.

FIG. 7 is a front view of the optical connector of FIG. 1.

FIG. 8 is a perspective view showing a state in which a pull tab is removed from the optical connector of FIG. 1.

FIG. 9 is a perspective view of an optical connector according to a modification.

FIG. 10 is a side view of the optical connector and an adapter of FIG. 9.

FIG. 11 is a perspective view of an optical connector according to an embodiment and an adapter different from the adapter of FIG. 4.

FIG. 12 is a side view of the optical connector and the adapter of FIG. 11.

### DETAILED DESCRIPTION

In an optical connector including an optical waveguide portion such as an optical fiber, a holding member configured to hold the optical waveguide portion, and a guide portion such as a guide pin, a structure in which the optical waveguide portion is provided between a pair of guide portions is known. However, in the above structure, the pair of guide portions and the optical waveguide portion are arranged along one direction, and a length of the holding member in the one direction is increased. Thus, there is room for improvement in terms of space-saving.

A structure in which an optical waveguide portion is provided at a position different from a position on a virtual straight line connecting a pair of guide portions is known. However, in this structure, since the optical waveguide portion is provided at a position different from the position on the virtual straight line, when the guide portion performs guiding and the holding member is inclined, optical loss may occur in the optical waveguide portion due to the influence of the inclination. Thus, it is required to reduce the optical loss.

An object of the present disclosure is to provide an optical connector capable of reducing optical loss.

According to the present disclosure, it is possible to reduce optical loss.

First, contents of the embodiments of the present disclosure will be listed and described. (1) An optical connector according to one embodiment is an optical connector to be connected to an adapter along a first direction. The optical connector includes an optical waveguide portion configured to guide light, a holding member configured to hold the optical waveguide portion, a guide portion provided at the holding member and configured to perform positioning with respect to the adapter, and a spring configured to urge the holding member toward the adapter. The optical waveguide portion extends in a second direction on an end surface of the holding member in the first direction, the second direction intersecting the first direction. The optical waveguide portion and the guide portion are arranged along a third direction on the end surface, the third direction intersecting the first direction and the second direction. The spring and the guide portion are arranged along the first direction. A position of the guide portion in the third direction coincides with a position of the spring in the third direction.

The optical connector is configured to be connected to the adapter along the first direction. The optical connector includes the optical waveguide portion, the holding member configured to hold the optical waveguide portion, and the guide portion configured to perform positioning the holding member with respect to the adapter. On the end surface of the holding member, the optical waveguide portion extends in the second direction, and the optical waveguide portion and the guide portion are arranged along the third direction intersecting the second direction. On the end surface of the holding member, a direction in which the optical waveguide portion extends and a direction in which the optical waveguide portion and the guide portion are arranged are different from each other, and thus it is possible to avoid an increase in size of the holding member. Thus, space saving can be achieved. The optical connector has the spring configured to urge the holding member toward the adapter, and the spring and the guide portion are arranged along the first direction. The position of the spring in the third direction coincides with the position of the guide portion in the third direction. Thus, the spring can urge the guide portion and the holding member toward the adapter along the first direction, so that the inclination of the holding member can be reduced. Thus, optical loss in the optical waveguide portion can be reduced.
(2) In the above (1), the optical connector may include a plurality of guide portions, and a latch structure configured to engage with the adapter. The latch structure may be located between the plurality of guide portions. In this case, the latch structure configured to engage with the adapter is located between the plurality of guide portions, and thus it is possible to achieve further space saving.
(3) In the above (2), a position of a center of the guide portion in the third direction when viewed in a direction opposite to the first direction and a position of a center of the latch structure in the third direction when viewed in the direction opposite to the first direction may coincide with each other. In this case, the inclination of the holding member can be more reliably reduced.
(4) In the above (2) or (3), the optical connector may further include a release member configured to release engagement of the latch structure with the adapter when the optical connector is pulled in a direction opposite to the first direction. In this case, the optical connector can be easily disengaged from the adapter.
(5) In the above (4), the optical connector may further include a pull tab extending from the release member in the opposite direction and being pinchable with fingers when pulling the release member. The pull tab may have a maximum length in the second direction smaller than a maximum length of the holding member in the second direction, and the pull tab may have a maximum length in the third direction smaller than a maximum length of the holding member in the third direction. In this case, since the pull tab extends from the release member in the direction opposite to the first direction, the engagement can be released more easily by pinching the pull tab with fingers and pulling the pull tab in the opposite direction. Since the maximum length of the pull tab in the second direction is smaller than the maximum length of the holding member in the second direction and the maximum length of the pull tab in the third direction is smaller than the maximum length of the holding member in the third direction, it is possible to avoid an increase in the size of the pull tab. Thus, this contributes to space saving.
(6) In the above (4) or (5), optical connector may further include a pull tab extending from the release member in the opposite direction and being pinchable with fingers when pulling the release member. The pull tab may be attachable to and detachable from the release member. In this case, when the pull tab is not necessary, the pull tab can be removed from the release member. Thus, the optical connector can be made small, which contributes to further space saving.

Specific examples of an optical connector according to an embodiment of the present disclosure will be described below with reference to the drawings. The present invention is not limited to the following examples, but is defined by the scope of the claims, and is intended to include meanings equivalent to the scope of the claims and all modifications within the scope. In the description of the drawings, the same or corresponding elements are denoted by the same reference signs, and duplicate descriptions will be omitted as appropriate. The drawings may be depicted partially in a simplified or exaggerated manner for ease of understanding, and dimensional ratios and the like are not limited to those shown in the drawings.

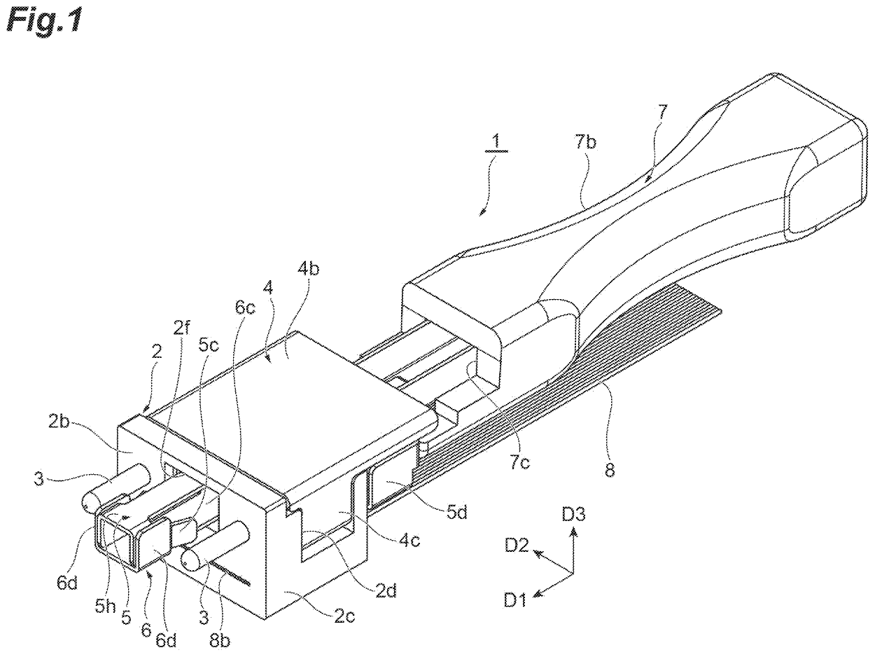

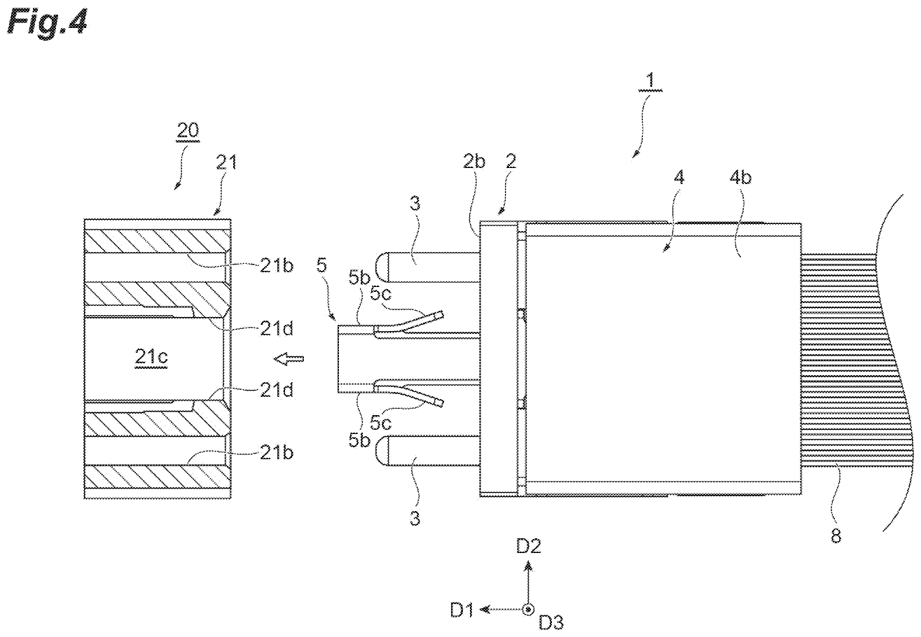

FIG. 1 is a perspective view of an optical connector 1 according to one embodiment. The optical connector 1 is connected to an adapter 20 (see FIG. 4) along a first direction D1. The optical connector 1 has a holding member 2, an optical waveguide portion 8 held by the holding member 2, and a guide portion 3 provided at the holding member 2 and configured to perform positioning with respect to the adapter 20. For example, the optical waveguide portion 8 is a plurality of optical fibers configured to guide light, and the holding member 2 is a ferrule. As an example, a material of the holding member 2 is polyphenylene sulfide (PPS).

The holding member 2 has an end surface 2b facing the adapter 20. As an example, the end surface 2b has a rectangular shape. The end surface 2b is located at an end of the holding member 2 in the first direction D1. On the end surface 2b, the optical waveguide portion 8 extends in a second direction D2 that is a direction intersecting the first direction D1. When the optical waveguide portion 8 is a plurality of optical fibers, for example, a distal end surfaces 8b of the plurality of optical fibers are arranged along the second direction D2. An end of the optical waveguide portion 8 in the first direction D1 is held by the holding member 2. The optical waveguide portion 8 extends from the holding member 2 in a direction opposite to the first direction D1.

For example, a length of the optical connector 1 in the first direction D1 is greater than a length of the optical connector 1 in the second direction D2. The end surface 2b extends in the second direction D2 and a third direction D3 that is a direction intersecting both the first direction D1 and the second direction D2. As an example, the first direction D1, the second direction D2, and the third direction D3 are orthogonal to each other. For example, a length of the end surface 2b in the second direction D2 is greater than a length of the end surface 2b in the third direction D3. The holding member 2 has, for example, a pair of side surfaces 2c arranged along the second direction D2. For example, the side surface 2c has a recessed portion 2d recessed from an end of the side surface 2c in the third direction D3 in a direction opposite to the third direction D3.

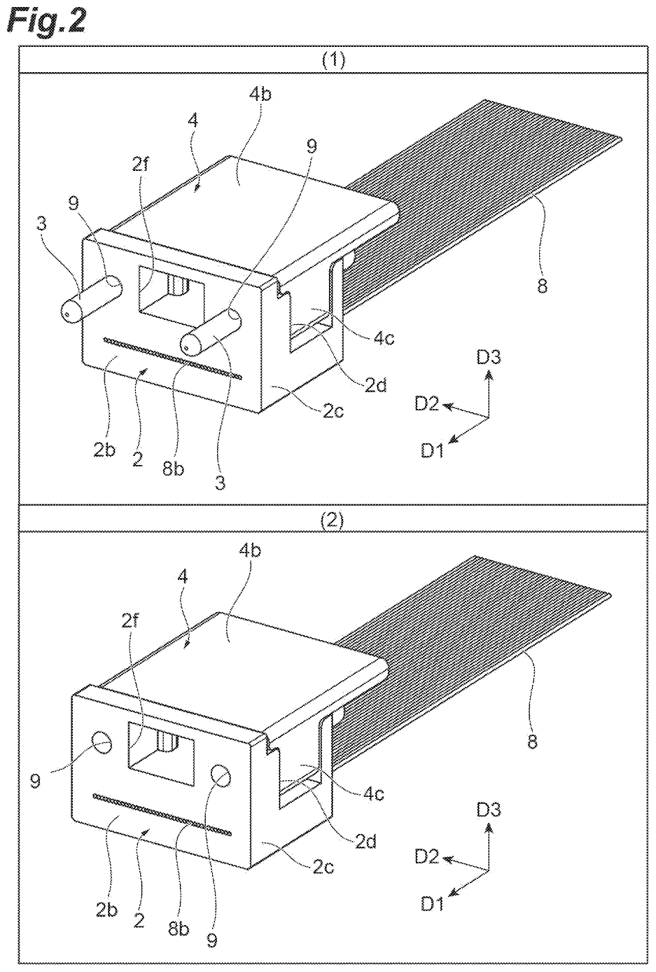

FIG. 2 is a perspective view showing some components of the optical connector 1. As shown in FIG. 1 and (1) of FIG. 2, for example, the guide portion 3 is a guide pin. A material of the guide portion 3 is, for example, steel use stainless (SUS). However, the material of the guide portion 3 may be a super hard material or a ceramic (as an example, zirconia), and is not particularly limited.

On the end surface 2b, the optical waveguide portion 8 and the guide portion 3 are arranged along the third direction D3. The optical connector 1 includes a plurality of (as an example, two) guide portions 3. The plurality of guide portions 3 are arranged along the second direction D2. For example, one of the guide portions 3 located at one end in the second direction D2 and an end of the optical waveguide portion 8 in the second direction D2 are arranged along the third direction D3.

For example, one of the guide portions 3 located at opposite end in the second direction D2 and an end of the optical waveguide portion 8 in the opposite direction are arranged along the third direction D3. The guide portion 3, which is a guide pin, is inserted into a guiding hole 9 that is recessed from the end surface 2b in the direction opposite to the first direction D1. However, as shown in (2) of FIG. 2, the guide portion may be the guiding hole 9.

The optical connector 1 has a latch structure 5 configured to engage with the adapter 20. The latch structure 5 is located in the third direction D3 of the optical waveguide portion 8. A material of the latch structure 5 is, for example, steel use stainless (SUS), but is not particularly limited. The latch structure 5 is, for example, processed by sheet metal processing. The latch structure 5 is located between the plurality of guide portions 3. For example, a part of the latch structure 5 is inserted into a hole 2f of the holding member 2. The hole 2f is recessed from the end surface 2b in the direction opposite to the first direction D1. The hole 2f is located between the pair of guide portions 3. As an example, the hole 2f has a rectangular shape.

The latch structure 5 includes, for example, a pair of metal plate portions 5b and a pair of leaf spring portions 5c. The leaf spring portion 5c extends from the metal plate portion 5b in the direction opposite to the first direction D1. The pair of leaf spring portions 5c are inclined with respect to the pair of metal plate portions 5b such that the pair of leaf spring portions 5c arranged along the second direction D2 are separated from each other as the pair of leaf spring portions 5c are separated from the pair of metal plate portions 5b. The leaf spring portion 5c is configured to be resiliently deformable along the second direction D2. The latch structure 5 will be described in detail later.

The optical connector 1 includes a covering member 4 that covers a portion of the holding member 2 located in the direction opposite to the first direction D1 with respect to the end surface 2b of the holding member 2. The covering member 4 has an upper surface portion 4b extending in the first direction D1 and the second direction D2, and a pair of side surface portions 4c arranged along the second direction D2. The side surface portion 4c extends in the first direction D1 and the third direction D3. The side surface portion 4c extends in the direction opposite to the third direction D3 from each of an end of the upper surface portion 4b in the second direction D2 and an end of the upper surface portion 4b in the direction opposite to the second direction D2. For example, an end of each side surface portion 4c in the direction opposite to the third direction D3 is hooked to the holding member 2.

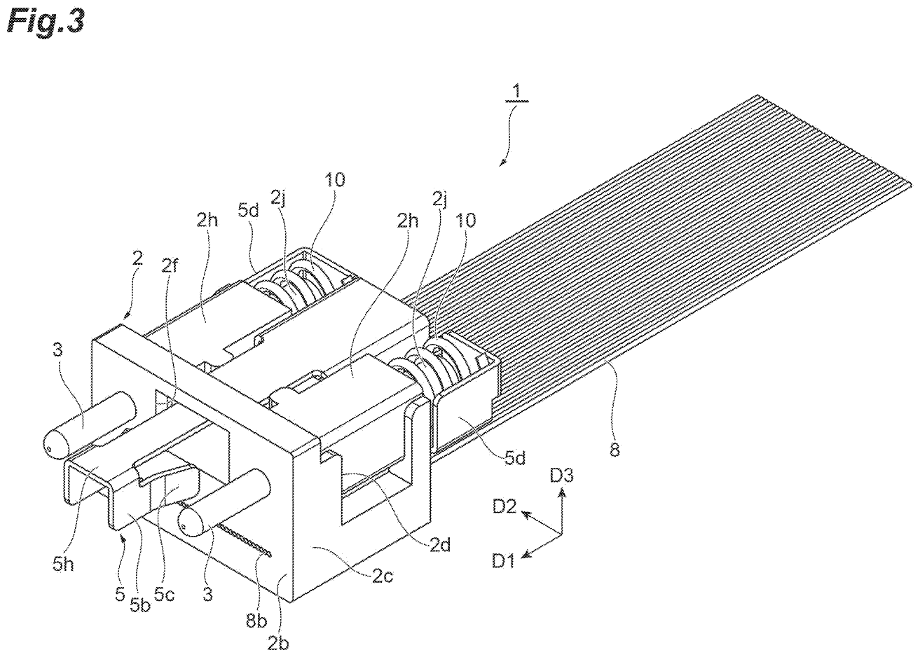

FIG. 3 is a perspective view showing the optical connector 1 in a state where the covering member 4 is removed. As shown in FIG. 3, the optical connector 1 has a spring 10 configured to urge the holding member 2 toward the adapter 20. The spring 10 is, for example, a coil spring (as an example, round spring). A material of the spring 10 is, for example, steel use stainless (SUS), but is not particularly limited. The spring 10 urges the holding member 2 in the first direction D1.

The optical connector 1 includes, for example, a plurality of springs 10. The plurality of springs 10 are arranged along the second direction D2. The spring 10 is located in the direction opposite to the first direction D1 of the guide portion 3. A position of the guide portion 3 in the third direction D3 coincides with a position of the spring 10 in the third direction D3. The definition of “coincidence” includes not only cases in which both are perfect matches, but also cases in which both do not match within a range that does not affect the effect.

The spring 10 and the guide portion 3 are arranged along the first direction D1. The spring 10, the holding member 2, and the guide portion 3 are arranged in this order. The optical connector 1 includes a placement portion 5d on which the spring 10 is placed. For example, the latch structure 5 includes the placement portion 5d. For example, the latch structure 5 has an extending portion 5h extending along the first direction D1 in the direction opposite to the third direction D3 of the covering member 4, and the placement portion 5d located in each of the second direction D2 of the extending portion 5h and the direction opposite to the second direction D2 of the extending portion 5h.

The holding member 2 has an extending portion 2h extending in the direction opposite to the first direction D1 with respect to the end surface 2b, and a protruding portion 2j protruding from the extending portion 2h in the opposite direction. The holding member 2 includes a plurality of (as an example, two) extending portions 2h and a plurality of protruding portions 2j. The plurality of extending portions 2h are arranged along the second direction D2, and the plurality of protruding portions 2j are arranged along the second direction D2. The extending portion 2h has, for example, a rectangular parallelepiped shape. The side surface portion 4c of the covering member 4 described above is hooked to the end of the extending portion 2h in the direction opposite to the third direction D3.

The protruding portion 2j has, for example, a columnar shape (as an example, a cylindrical shape). The protruding portion 2j is inserted into the spring 10 placed on the placement portion 5d. The spring 10 is interposed between the placement portion 5d and the extending portion 2h. One end of the spring 10 abuts against an end of the placement portion 5d in the direction opposite to the first direction D1. The spring 10 urges the extending portion 2h of the holding member 2 in the first direction D1 in a state of abutting against the placement portion 5d.

FIG. 4 is a diagram showing the optical connector 1 and the adapter 20. As shown in FIG. 4, the adapter 20 has a body portion 21 with which the latch structure 5 is engaged and into which the guide portion 3 is inserted, for example. The body portion 21 has, for example, a rectangular parallelepiped shape. The body portion 21 has a guiding hole 21b into which the guide portion 3 is inserted and a latch hole 21c into which the latch structure 5 is inserted. The guide portion 3 is inserted into the guiding hole 21b in the first direction D1. The latch structure 5 is inserted into the latch hole 21c in the first direction D1. The body portion 21 has a pair of projecting portions 21d facing each other along the second direction D2 in the latch hole 21c.

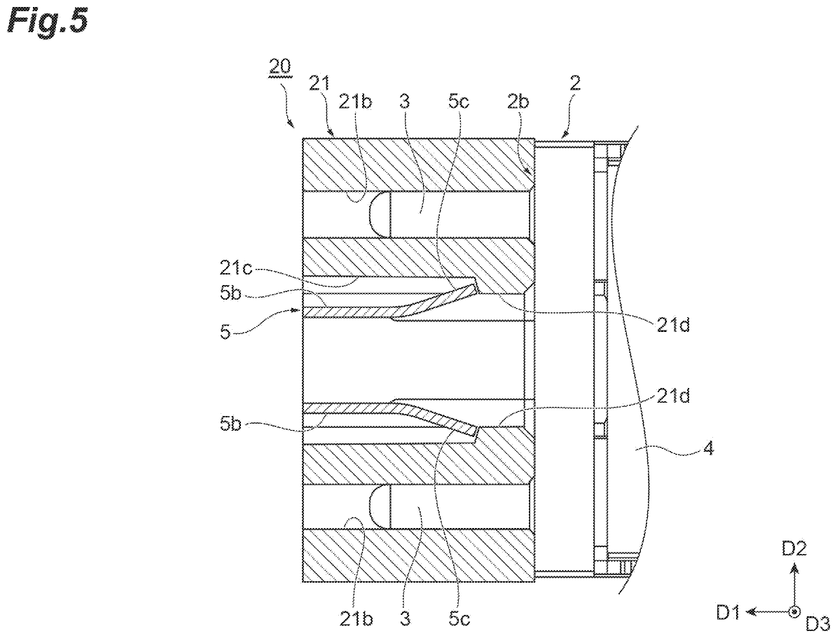

FIG. 5 is a cross-sectional view showing a state where the latch structure 5 is inserted into the latch hole 21c. As shown in FIGS. 4 and 5, when the latch structure 5 is inserted into the latch hole 21c, the leaf spring portion 5c abuts against the projecting portion 21d, and the pair of leaf spring portions 5c are resiliently deformed in a direction in which the leaf spring portions 5c approach each other. When the latch structure 5 is further inserted, the leaf spring portion 5c goes beyond the projecting portion 21d in the first direction D1, and the pair of leaf spring portions 5c spread in a direction away from each other, so that each leaf spring portion 5c is hooked to each projecting portion 21d. As a result, the latch structure 5 is engaged with the adapter 20.

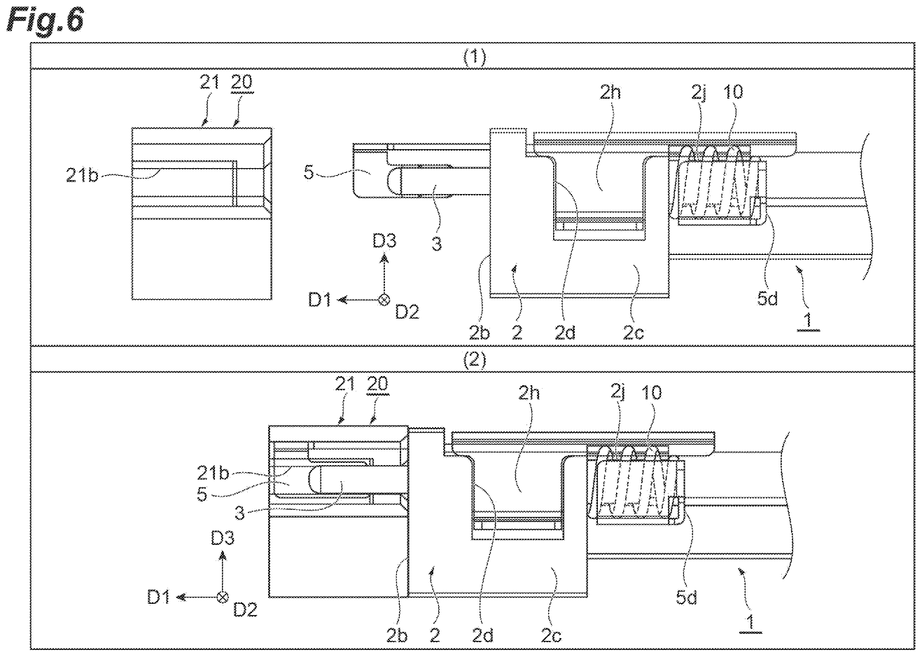

(1) and (2) of FIG. 6 are side views showing states before and after the optical connector 1 is connected to the adapter 20. As shown in FIGS. 5 and 6, when the latch structure 5 is engaged with the adapter 20, the guide portion 3 is inserted into the guiding hole 21b of the adapter 20. The guide portion 3 is inserted into the guiding hole 21b, whereby the optical connector 1 is performed positioning with respect to the adapter 20. As described above, the spring 10 is disposed between the placement portion 5d of the latch structure 5 and the extending portion 2h of the holding member 2. The spring 10 urges the holding member 2 with respect to the latch structure 5 in the first direction D1. Since the holding member 2 is urged toward the adapter 20 by the spring 10, the end surface 2b can be brought into close contact with the adapter 20 to reduce the inclination of the holding member 2.

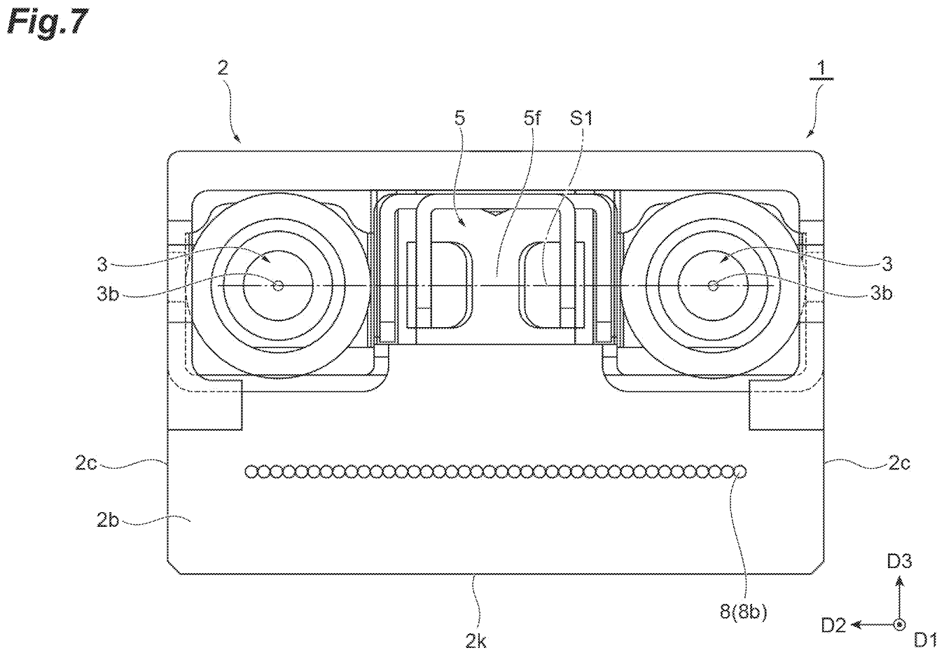

FIG. 7 is a front view of the optical connector 1 when the optical connector 1 is viewed in the direction opposite to the first direction D1. As shown in FIG. 7, a position of a center 3b of the guide portion 3 in the third direction D3 when viewed in the direction opposite to the first direction D1 and a position of a center 5f of the latch structure 5 in the third direction D3 when viewed in the direction opposite to the first direction D1 coincide with each other. For example, a distance from a bottom surface 2k of the holding member 2 to the center 3b of the guide portion 3 is equal to a distance from the bottom surface 2k to the center 5f of the latch structure 5. The bottom surface 2k extends in the first direction D1 and the second direction D2 at an end of the holding member 2 in the direction opposite to the third direction D3.

The center 3b of the guide portion 3 and a center of the spring 10 coincide with each other. That is, the center of the spring 10 and the center 3b of the guide portion 3 are arranged along the first direction D1. This makes it possible to stabilize the biasing force of the spring 10 against the guide portion 3. The center of the spring 10 and the center 5f of the latch structure 5 may be located on the same plane as a plane S1 that includes the center 3b of the guide portion 3 and extends in the first direction D1 and the second direction D2. However, at least one of the position of the center of the spring 10 or a position of the center 5f of the latch structure 5 may be shifted from the plane S1 within a range that does not affect the effect.

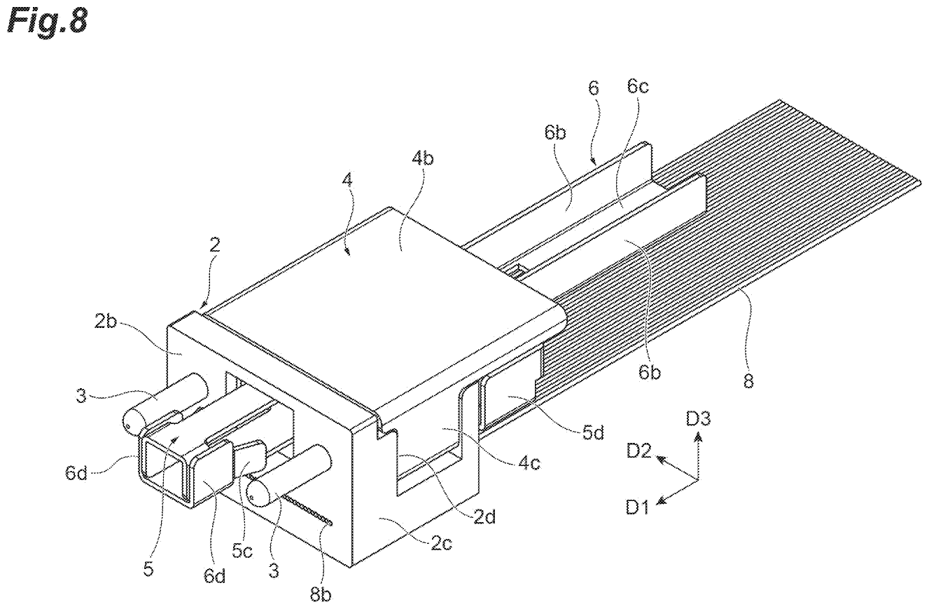

As shown in FIG. 1, the optical connector 1 has a release member 6 configured to release engagement of the latch structure 5 with the adapter 20, and a pull tab 7 that is pinchable with fingers when pulling the release member 6. FIG. 8 is a perspective view showing a state in which the pull tab 7 is removed from the optical connector 1 of FIG. 1. As shown in FIGS. 1 and 8, the release member 6 has, for example, a pair of side wall portions 6b arranged along the second direction D2, and a bottom wall portion 6c located between the pair of side wall portions 6b and extending in the first direction D1 and the second direction D2. A material of the release member 6 is, for example, steel use stainless (SUS), but is not particularly limited.

The release member 6 is located in the third direction D3 of the optical waveguide portion 8. The release member 6 has a release portion 6d configured to release engagement of the latch structure 5 with the adapter 20. The release portion 6d is located, for example, at an end of the release member 6 in the first direction D1. The release portion 6d has a plate shape extending in the first direction D1 and the third direction D3 and being thick in the second direction D2. The release member 6 has a pair of release portions 6d, and the pair of release portions 6d are arranged along the second direction D2.

The release member 6 is configured to be movable relative to the latch structure 5 by a predetermined distance in the direction opposite to the first direction D1. When the release member 6 is pulled in the direction opposite to the first direction D1 and the release member 6 moves relative to the latch structure 5 in the opposite direction, the pair of release portions 6d resiliently deform the pair of leaf spring portions 5c in the direction of approaching each other, and the pair of leaf spring portions 5c pass over the pair of projecting portions 21d in the opposite direction. Thus, the latch structure 5 can be easily disengaged from the adapter 20.

A material of the pull tab 7 is, for example, resin. The pull tab 7 extends from the release member 6 in the direction opposite to the first direction D1. The pull tab 7 has, for example, a hole 7c into which the release member 6 is inserted. The pull tab 7 is attached to the release member 6 by engagement between projection and recess, for example. As an example, the pull tab 7 is attached to the release member 6 by fitting the release member 6 into the hole 7c. The pull tab 7 is configured to be attachable to and detachable from the release member 6, for example. However, the pull tab 7 may be non-detachably attached to the release member 6.

For example, a cross section of the pull tab 7 when cut by a plane orthogonal to the first direction D1 has a corner-rounded rectangular shape. The pull tab 7 has a narrowed portion 7b at a center of the first direction D1 of the pull tab 7, for example. In the narrowed portion 7b, a length of the pull tab 7 in the second direction D2 decreases toward the center of the pull tab 7 in the first direction D1. Since the pull tab 7 has the narrowed portion 7b, the pull tab 7 can be formed in a shape that is easily pinched with fingers. The pull tab 7 is located in the third direction D3 of the optical waveguide portion 8. For example, a maximum length of the pull tab 7 in the second direction D2 is smaller than a maximum length of the holding member 2 in the second direction D2, and the maximum length of the pull tab 7 in the third direction D3 is smaller than the maximum length of the holding member 2 in the third direction D3.

Effects obtained from the optical connector 1 according to the present embodiment will be described. The optical connector 1 is connected to the adapter 20 along the first direction D1. The optical connector 1 includes the optical waveguide portion 8, the holding member 2 configured to hold the optical waveguide portion 8, and the guide portion 3 configured to perform positioning the holding member 2 with respect to the adapter 20. On the end surface 2b of the holding member 2, the optical waveguide portion 8 extends in the second direction D2, and the optical waveguide portion 8 and the guide portion 3 are arranged along the third direction D3 intersecting the second direction D2. On the end surface 2b of the holding member 2, a direction (second direction D2) in which the optical waveguide portion 8 extends and a direction (third direction D3) in which the optical waveguide portion 8 and the guide portion 3 are arranged are different from each other, and thus it is possible to avoid an increase in size of the holding member 2. Thus, space saving can be achieved.

The optical connector 1 has the spring 10 configured to urge the holding member 2 toward the adapter 20, and the spring 10 and the guide portion 3 are arranged along the first direction D1. The position of the spring 10 in the third direction D3 coincides with the position of the guide portion 3 in the third direction D3. That is, the spring 10 is located on the plane S1 described above. Thus, the spring 10 can urge the guide portion 3 and the holding member 2 toward the adapter 20 along the first direction D1, so that inclination of the end surface 2b of the holding member 2 can be reduced. Thus, the end surface 2b can be brought into close contact with the adapter 20, and thus optical loss in the optical waveguide portion 8 can be reduced.

As a method of measuring the inclination of the end surface 2b of the holding member 2, for example, a method using an autocollimator is exemplified. In this case, the inclination of the end surface 2b can be measured by irradiating the holding member 2 with laser light along the third direction D3, for example. Further, the inclination of the end surface 2b can be estimated by measuring the degree of coupling loss when the optical waveguide portion 8 is irradiated with a Gaussian beam. As described above, various methods can be used to measure the inclination of the end surface 2b.

The center of the spring 10 and the center 5f of the latch structure 5 may be located on the same plane as the plane S1. In this case, the inclination of the end surface 2b of the holding member 2 with respect to a virtual plane orthogonal to the first direction D1 (hereinafter, may be referred to as the virtual plane) can be made close to zero. For example, when the position of the center of the spring 10 is shifted by 1 mm in the second direction D2 with respect to the plane S1, the inclination of the end surface 2b with respect to the virtual plane is about 0.4°, and when the position of the center of the spring 10 is shifted by 1 mm in the third direction D3 with respect to the plane S1, the inclination of the end surface 2b with respect to the virtual plane is about 2.2°. When the position of the center of the spring 10 is shifted by 0.2 mm in the second direction D2 with respect to the plane S1, the inclination of the end surface 2b with respect to the virtual plane is about 0.05°, and when the position of the center of the spring 10 is shifted by 0.2 mm in the third direction D3 with respect to the plane S1, the inclination of the end surface 2b with respect to the virtual plane is about 0.2°.

For example, when the position of the center 5f of the latch structure 5 is shifted by 1 mm in the third direction D3 with respect to the plane S1, the inclination of the end surface 2b with respect to the virtual plane is about 6.5°. When the position of the center 5f of the latch structure 5 is shifted by 0.2 mm in the third direction D3 with respect to the plane S1, the inclination of the end surface 2b with respect to the virtual plane is about 0.6°. As described above, when the amount of deviation of the center of the spring 10 with respect to the plane S1 and the amount of deviation of the center 5f of the latch structure 5 with respect to the plane S1 are small, the inclination of the end surface 2b with respect to the virtual plane can be reduced, and thus the optical loss in the optical waveguide portion 8 can be reduced.

The optical connector 1 may include the plurality of guide portions 3 and the latch structure 5 configured to engage with the adapter 20. The latch structure 5 may be located between the plurality of guide portions 3. In this case, the latch structure 5 configured to engage with the adapter 20 is located between the plurality of guide portions 3, thus it is possible to achieve further space saving.

The position of the center 3b of the guide portion 3 in the third direction D3 when viewed in the direction opposite to the first direction D1 and the position of the center 5f of the latch structure 5 in the third direction D3 when viewed in the direction opposite to the first direction D1 may coincide with each other. In this case, the inclination of the holding member 2 can be more reliably reduced.

The optical connector 1 may include the release member 6 configured to release engagement of the latch structure 5 with the adapter 20 when the optical connector 1 is pulled in the direction opposite to the first direction D1. In this case, the optical connector 1 can be easily disengaged from the adapter 20.

The optical connector 1 may include the pull tab 7 that extends from the release member 6 in the opposite direction and is pinchable with fingers when pulling the release member 6. The maximum length of the pull tab 7 in the second direction D2 may be smaller than the maximum length of the holding member 2 in the second direction D2, and the maximum length of the pull tab 7 in the third direction D3 may be smaller than the maximum length of the holding member 2 in the third direction D3. In this case, since the pull tab 7 extends from the release member 6 in the direction opposite to the first direction D1, the engagement can be released more easily by pinching the pull tab 7 with fingers and pulling the pull tab 7 in the opposite direction. The maximum length of the pull tab 7 in the second direction D2 is smaller than the maximum length of the holding member 2 in the second direction D2, and the maximum length of the pull tab 7 in the third direction D3 is smaller than the maximum length of the holding member 2 in the third direction D3, so that the increase in the size of the pull tab 7 can be avoided. Thus, this contributes to space saving.

The pull tab 7 may be attachable to and detachable from the release member 6. In this case, when the pull tab 7 is not necessary, the pull tab 7 can be removed from the release member 6. Thus, the optical connector 1 can be made small, which contributes to further space saving.

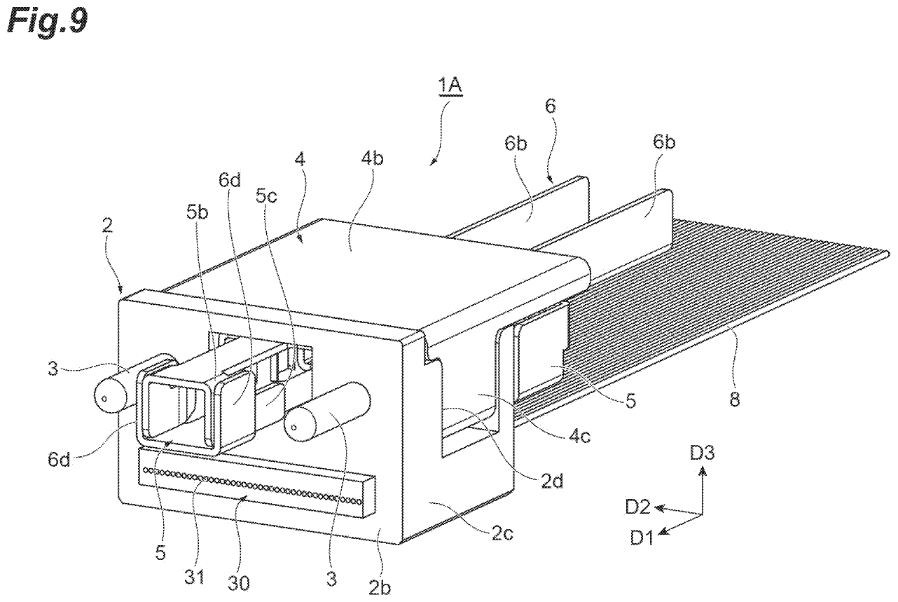

The modification of the optical connector according to the present disclosure will be described. Some configurations of an optical connector according to the modification described later are the same as some configurations of the optical connector 1 described above. Thus, in the following description, the same configurations as those described above are denoted by the same reference signs, and duplicate description thereof will be omitted as appropriate. FIG. 9 is a perspective view of an optical connector 1A according to a modification. As shown in FIG. 9, the optical connector 1A has a lens array 30 fixed to the end surface 2b of the holding member 2.

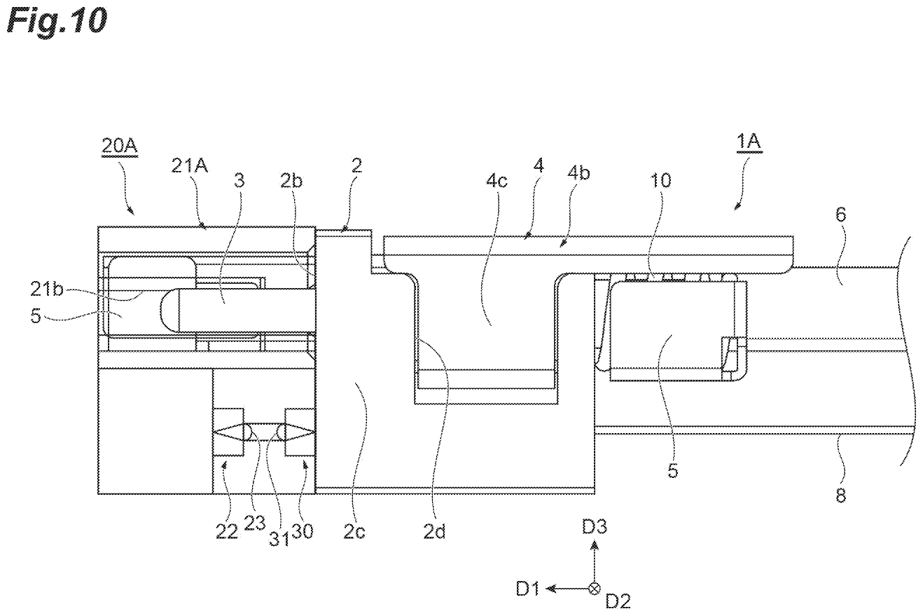

FIG. 10 is a diagram showing a state where the optical connector 1A is connected to an adapter 20A. The adapter 20A is different from the above-described adapter 20 in that the adapter 20A includes a lens array 22. As shown in FIGS. 9 and 10, the lens array 30 has a plurality of lenses 31 arranged along the second direction D2, and the lens array 22 has a plurality of lenses 23 arranged along the second direction D2. A material of each of the lens 31 and the lens 23 may be a material that is transparent in the wavelength band of light to be used, and is, for example, glass or silicon. The optical waveguide portion 8, the lens 31 and the lens 23 are optically coupled to each other. The lens 31 and the lens 23 are optically coupled to each other by expanded light.

The embodiment and modification of the optical connector according to the present disclosure have been described above. However, the optical connector according to the present disclosure is not limited to the contents of embodiment or modification described above, and may be further modified within the scope of the concept described in the claims. That is, the shape, size, material, number, and arrangement of each portion of the optical connector according to the present disclosure can be modified as appropriate within the scope of the concept.

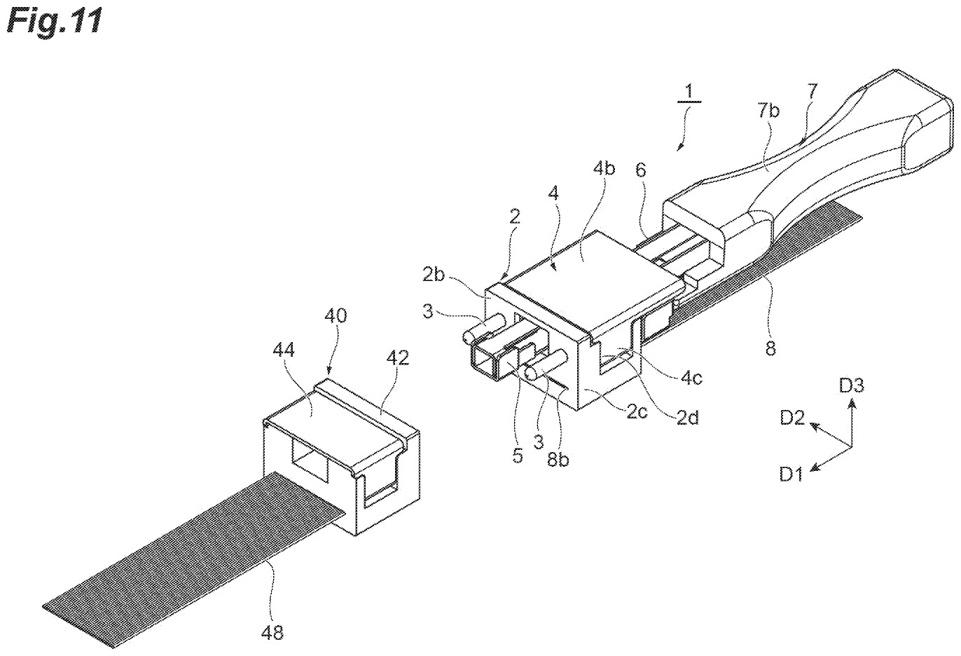

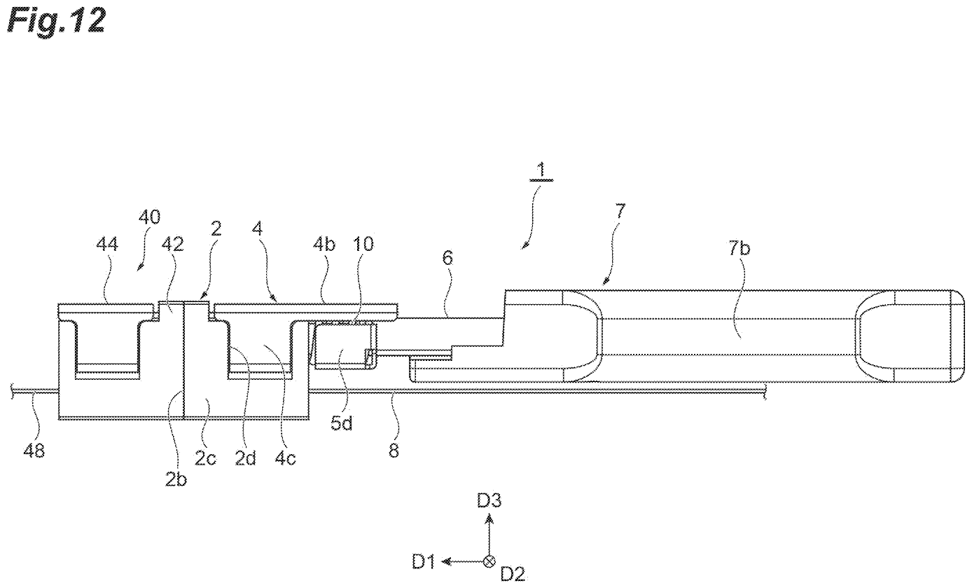

For example, as shown in FIGS. 11 and 12, the optical connector 1 may be connected to an adapter 40 different from the adapter 20 described above. The adapter 40 has a shape similar to that of the optical connector 1. The adapter 40 includes an optical waveguide portion 48, a holding member 42 configured to hold the optical waveguide portion 48, and a covering member 44 that covers a part of the holding member 42, and a guiding hole into which the guide portion 3 of the optical connector 1 is inserted is formed in the holding member 42. As in the case of the adapter 40, the shape of the adapter to which the optical connector is connected can also be changed as appropriate.

In the above-described embodiment, an example in which the center of the spring 10 is located on the same plane as the plane S1 including the center 3b of the guide portion 3 and extending in the first direction D1 and the second direction D2 has been described. However, the position of the center of the spring 10 in the third direction D3 may be shifted with respect to the plane S1. For example, when load in the third direction D3 is continuously applied to the optical waveguide portion 8, the position of the center of the spring 10 may be shifted in the direction opposite to the third direction D3 with respect to the plane S1. In this case, the bending moment can be reduced by spring load of the spring 10.

In the above-described embodiment, the optical connector 1 in which the latch structure 5 is provided between the pair of guide portions 3 has been described. However, the position of the latch structure that engages with the adapter is not limited to the case of the latch structure 5, and can be changed as appropriate. In the above-described embodiment, an example was described in which the optical waveguide portion 8 is a plurality of optical fibers, and the holding member 2 is a ferrule. However, the optical waveguide portion may be an optical waveguide that functions as a core, and the holding member may be a cladding that surrounds the optical waveguide. As described above, the configurations of the optical waveguide portion and the holding member can also be changed as appropriate.

What is claimed is:

1. An optical connector to be connected to an adapter along a first direction, the optical connector comprising:
an optical waveguide portion configured to guide light;
a holding member configured to hold the optical waveguide portion;
a guide portion provided at the holding member and configured to perform positioning with respect to the adapter; and
a spring configured to urge the holding member toward the adapter,
wherein the optical waveguide portion extends in a second direction on an end surface of the holding member in the first direction, the second direction intersecting the first direction,
wherein the optical waveguide portion and the guide portion are arranged along a third direction on the end surface, the third direction intersecting the first direction and the second direction,
wherein the spring and the guide portion are arranged along the first direction, and
wherein a position of the guide portion in the third direction coincides with a position of the spring in the third direction.

2. The optical connector according to claim 1,
wherein the guide portion includes a plurality of guide portions,
wherein the optical connector includes a latch structure configured to engage with the adapter, and
wherein the latch structure is located between the plurality of guide portions.

3. The optical connector according to claim 2,
wherein a position of a center of the guide portion in the third direction when viewed in the direction opposite to the first direction and a position of a center of the latch structure in the third direction when viewed in the direction opposite to the first direction coincide with each other.

4. The optical connector according to claim 2, further comprising:
a release member configured to release engagement of the latch structure with the adapter when the optical connector is pulled in a direction opposite to the first direction.

5. The optical connector according to claim 4, further comprising:
a pull tab extending from the release member in the opposite direction and being pinchable with fingers when pulling the release member,
wherein the pull tab has a maximum length in the second direction smaller than a maximum length of the holding member in the second direction, and the pull tab has a maximum length in the third direction smaller than a maximum length of the holding member in the third direction.

6. The optical connector according to claim 4, further comprising:
a pull tab extending from the release member in the opposite direction and being pinchable with fingers when pulling the release member,
wherein the pull tab is attachable to and detachable from the release member.
